(19) United States
(12) Patent Application Publication
(10) Pub. No.: US 2005/0103987 A1
(43) Pub. Date: May 19, 2005

(54) Semiconductor component, wafer and package having an optical sensor

(75) Inventors: Remi Brechignac, Grenoble (FR); Jonathan Hurwitz, Edinburgh (GB)

Correspondence Address: JENKENS & GILCHRIST, PC, 1445 ROSS AVENUE, SUITE 3200, DALLAS, TX, 75202, US

(73) Assignee: STMicroelectronics S.A., Montrouge (FR)

(21) Appl. No.: 10/958,673

(22) Filed: Oct. 5, 2004

(30) Foreign Application Priority Data
Oct. 6, 2003 (FR) 03 11675

(51) Int. Cl. H01J 5/16

(52) U.S. Cl. 250/226; 250/239

(57) ABSTRACT

A semiconductor component, semiconductor wafer and semiconductor package include an integrated-circuit chip having, on a front face, an optical sensor and electrical connection pads between the edge of this face and this optical sensor. A protective patch made of a transparent material is placed in front of the optical sensor but does not cover the said optical connection pads. The said protective patch is fixed to the front face of the said chip by a bead of an adhesive extending annularly between, and at a certain distance from, the edge of the said optical sensor and of the electrical connection pads. At least one of the faces of the patch is covered with a protective layer of a material that filters out infrared light rays.

### PRIORITY CLAIM

The present application claims priority from French Application for Patent No. 03 11675 filed Oct. 6, 2003, the disclosure of which is hereby incorporated by reference.

### BACKGROUND OF THE INVENTION

1. Technical Field of the Invention

The present invention relates to the general field of semiconductor devices and more particularly to the field of semiconductor devices having optical sensors.

2. Description of Related Art

Known at the present time are semiconductor packages that comprise a body that contains an integrated-circuit chip having an optical sensor, this body having, in an aperture, an optical lens placed in front of, and at a certain distance from, the optical sensor. The package body is furthermore equipped with a protective glass plate that is placed between, and at a certain distance from, the integrated-circuit chip and the lens, and the periphery of which is fixed to an annular part of the package body. One face of this glass plate is covered with a protective layer made of a material that prevents infrared light rays from disturbing the operation of the optical sensor.

Such an arrangement requires a special and relatively bulky arrangement of the package body for fixing the protective plate, the provision of a protective plate of relatively large area, an amount of covering material proportional to this area, while this material is relatively expensive, and special operations for mounting this plate. In addition, the protective plate is fixed to the package body at the end of the fabrication process, so that the optical sensor is not protected during the various prior steps and if particles are deposited on this optical sensor during these prior steps, the package fabricated has to be scrapped.

There exists a need in the art to simplify semiconductor devices having optical sensors requiring the latter to be protected against infrared light radiation, to improve the operations for fabricating them, and to reduce their costs, especially by reducing the amounts of material used for protecting the optical sensors.

### SUMMARY OF THE INVENTION

An embodiment of the present invention includes a semiconductor component comprising an integrated-circuit chip having, on a front face, an optical sensor and electrical connection pads between the edge of this face and this optical sensor.

According to an embodiment of the invention, the component includes a protective patch made of a transparent material placed in front of the optical sensor but not covering the electrical connection pads, the protective patch being fixed to the front face of the chip by a bead of an adhesive extending annularly between, and at a certain distance from, the edge of the optical sensor and of the electrical connection pads, and at least one of the faces of the patch being covered with a protective layer of a material that filters out infrared light rays.

An embodiment of the present invention includes a semiconductor wafer comprising at a multiplicity of locations, integrated-circuit chips each having, on a front face, an optical sensor and electrical connection pads around the periphery of each optical sensor.

According to an embodiment of the invention, the wafer is provided with protective patches made of a transparent material that are placed in front of the optical sensors but do not cover the electrical connection pads, each patch being fixed to the front face of each chip by a bead of an adhesive extending annularly between, and at a certain distance from, the edge of the optical sensor and of the electrical connection pads, and at least one of the faces of the patches being covered with a protective layer of a material that filters out infrared light rays.

An embodiment of the present invention includes a semiconductor package comprising a body containing an integrated-circuit chip, a front face of which has an optical sensor, and carrying an optical lens placed in front of, and at a certain distance from, this optical sensor.

According to an embodiment of the invention, the package furthermore includes a protective patch made of a transparent material placed in front of the optical sensor, the patch being fixed to the front face of the chip by a bead made of an adhesive extending annularly at a certain distance from the edge of the optical sensor, and at least one of the faces of the patch being covered with a protective layer made of a material that filters out infrared light rays.

An embodiment of the present invention includes a semiconductor package comprising a body having an electrical connection support plate and an annular support lying in front of the said support plate, an integrated-circuit chip, a rear face of which is fixed to a front face of the said support plate and a front face of which has an optical sensor and electrical connection pads between the edge of this face and this optical sensor, electrical connection wires between the said electrical connection pads and electrical connection regions formed on the front face of the said support plate, and a lens carried by the said annular support and placed in front of, and at a certain distance from, the said optical sensor.

According to an embodiment of the invention, the package furthermore includes a protective patch made of a transparent material placed in front of the optical sensor but not covering the electrical connection pads, the patch being fixed to the front face of the chip by a bead of an adhesive extending annularly between, and at a certain distance from, the edge of the optical sensor and of the electrical connection pads, and at least one of the faces of the patch being covered with a protective layer made of a material that filters out infrared light rays.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIG. 1 shows a schematic cross section through an optical semiconductor package according to the prevent invention;

FIGS. 2 to 4 show schematic sections of the aforementioned optical semiconductor package at various fabrication steps, according to a first embodiment; and

FIGS. 5 to 7 show a schematic cross section through an optical semiconductor package according to another embodiment.

### DETAILED DESCRIPTION OF THE DRAWINGS

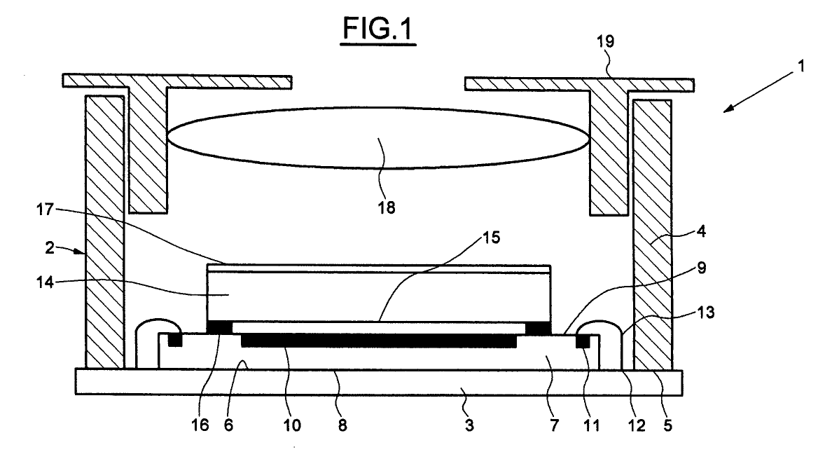

FIG. 1 shows a semiconductor package 1 that comprises a body 2 formed by an electrical connection support plate 3 provided with surface or integrated electrical connection lines (not shown) and by an annular support 4, the rear edge 5 of which is fixed to the periphery of the front face 6 of the support plate 3.

The semiconductor package 1 includes an integrated-circuit chip 7 placed inside the body 2, the rear face 8 of which is fixed to the front face 6 of the support plate 3 and the front face 9 of which has, approximately in its central part, an optical sensor 10 and, a short distance from its edges, electrical connection pads 11.

The electrical connection pads 11 are connected to electrical connection regions 12, made on the front face 6 of the support plate 3, by electrical connection wires 13 that extend into the space separating the inner wall of the annular support 4 from the periphery of the chip 7.

The chip 7 is provided on its front face 9 with a transparent protective patch 14, namely made of glass, placed at the front of the optical sensor 10. This patch 14 covers the optical sensor 10 and extends beyond its edge without covering the electrical connection pads 11.

The rear face 15 of the patch 14 is fixed to the front face 9 of the chip 7 by means of an annular bead 16 of an adhesive, which extends around, at a certain distance from, the sensor 10 and passes between this edge and the electrical connection pads 11. Thus, between the optical sensor 10 and the rear face 15 of the patch 14 there is a space defined by the thickness of the bead 16.

The front face 17 of the patch 14 is provided with a protective layer 17 that filters out infrared light radiation.

The annular support 4 carries, in its front aperture, an optical lens 18 by means of an adjustment ring 19, this optical lens 10 being placed at a certain distance from and facing the front of the patch 14, and its optical axis corresponding to the optical axis of the optical sensor 10.

It follows from the foregoing that any infrared light radiation that passes through the lens 18 and reaches the front of the patch 14 is filtered out by the protective layer 17 and therefore does not reach the optical sensor 10 of the chip 7.

Moreover, the use of a protective patch 14 fixed directly to the chip 7 and slightly larger in size than the area of the optical sensor 10 makes it possible to limit the necessary amount of material forming the protective layer 17.

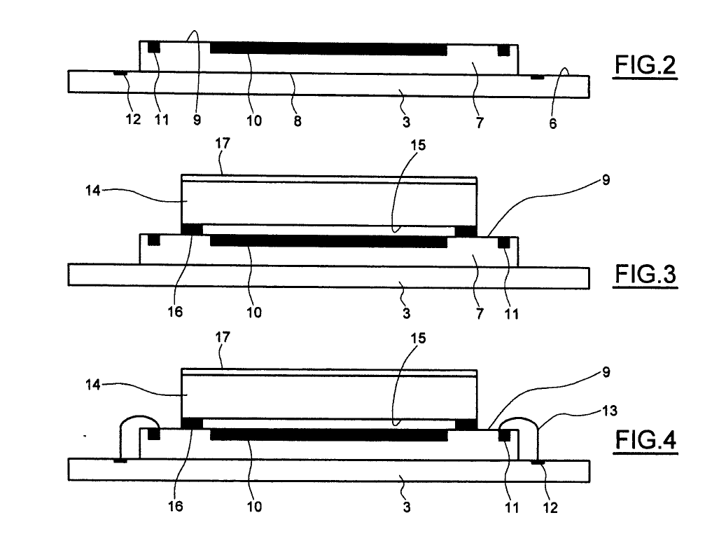

To fabricate the semiconductor package 1 in a first embodiment shown in FIGS. 2 to 4, the procedure may be as follows.

As shown in FIG. 2, starting from an electrical connection support plate 3 and an integrated-circuit chip 7, the rear face 8 of the chip 7 is fixed, for example by means of a layer of adhesive, to the front face 10 of the support plate 3 at a predetermined place, the electrical connection regions 12 of the support plate 3 being to the outside of, and at a certain distance from, the periphery of the chip 7.

Next, as shown in FIG. 3, a bead 16 of adhesive is deposited either on the front face 9 of the chip 7, this bead extending as described previously, or around the periphery of the rear face 15 of a glass patch 14.

Next, the patch 14 is installed on the chip 7 in order to fix it by means of the bead of adhesive 16.

Having done this, a semiconductor component formed in particular from the chip 7 provided with the protective patch 14 is obtained, in such a way that the optical sensor 10 of the chip 7 is protected by the patch 14 against any deposition of particles deleterious to its subsequent proper operation, especially during the subsequent operations of the fabrication process.

Next, as shown in FIG. 4, the electrical connection wires 13 are put into place in order to connect the electrical connection pads 11 of the chip 7, that are located beyond the periphery of the patch 14, to the electrical connection regions 12 of the support plate 3.

Finally, the annular support 4, provided with the lens 18, is put in place on and fixed to the periphery of the front face of the support plate 3 by means of a layer of adhesive interposed between the rear face 5 of the annular support 4 and the front face 6 of the support plate 3.

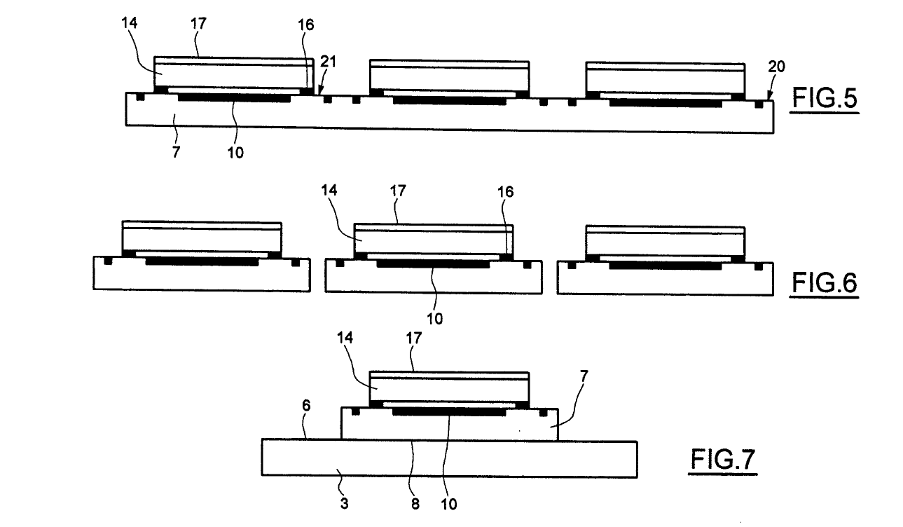

The semiconductor package 1 may also be fabricated according to an alternative embodiment shown in FIGS. 5 to 7.

As may be seen in FIG. 5, the starting point is a semiconductor wafer 20 having integrated-circuit chips 7 at various juxtaposed locations 21.

As described above with reference to FIG. 3, a glass patch 14 is placed on and fixed to each chip 7, this time at each location 21 on the wafer 20. Insofar as the chips 7 on the wafer 20 would have been tested beforehand, patches 14 would of course not be placed on the defective chips.

Next, as shown in FIG. 6, the wafer 20 is cut up so as to obtain individual components, each composed of a chip 7 provided with a protective patch 14.

Thus, right from this primary fabrication step, the optical sensors 10 of the chips 7 that result from the wafer 20 are protected by the patches 14 against deleterious particles being subsequently deposited.

Next, as shown in FIG. 7, the various chips 7 provided with the patches 14 are fixed to the front face 6 of the electrical connection support plate 3 as described with reference to FIG. 2.

The electrical connection wires are then put in place as described with reference to FIG. 4 and the annular support 4 is fitted, as described above.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A semiconductor component comprising:
an integrated-circuit chip having, on a front face, an optical sensor and electrical connection pads between the edge of the face and the optical sensor;
a protective patch made of a transparent material placed in front of the optical sensor but not covering the electrical connection pads, the protective patch being fixed to the front face of the chip by a bead of an adhesive extending annularly between, and at a certain distance from, the edge of the optical sensor and of the electrical connection pads; and
at least one face of the patch being covered with a protective layer of a material that filters out infrared light rays.

2. A semiconductor wafer comprising:
integrated-circuit chips at a multiplicity of locations each having, on a front face, an optical sensor and electrical connection pads around the periphery of each optical sensor;
protective patches made of a transparent material that are placed in front of the optical sensors but do not cover the electrical connection pads, each patch being fixed to the front face of each chip by a bead of an adhesive extending annularly between, and at a certain distance from, the edge of the optical sensor and of the electrical connection pads; and
at least one of the faces of the patches being covered with a protective layer of a material that filters out infrared light rays.

3. A semiconductor package comprising:
a body containing an integrated-circuit chip, a front face of which has an optical sensor, and carrying an optical lens placed in front of, and at a certain distance from, this optical sensor;
a protective patch made of a transparent material placed in front of the optical sensor, the patch being fixed to the front face of the chip by a bead made of an adhesive extending annularly at a certain distance from the edge of the optical sensor; and
at least one of the faces of the patch being covered with a protective layer made of a material that filters out infrared light rays.

4. A semiconductor package comprising:
a body having an electrical connection support plate and an annular support lying in front of the support plate;
an integrated-circuit chip, a rear face of which is fixed to a front face of the support plate and a front face of which has an optical sensor and electrical connection pads between the edge of the face and the optical sensor;
electrical connection wires between the electrical connection pads and electrical connection regions formed on the front face of the support plate;
a lens carried by the annular support and placed in front of, and at a certain distance from, the optical sensor;
a protective patch made of a transparent material placed in front of the optical sensor but not covering the electrical connection pads, the patch being fixed to the front face of the chip by a bead of an adhesive extending annularly between, and at a certain distance from, the edge of the optical sensor and of the electrical connection pads; and
at least one of the faces of the patch being covered with a protective layer made of a material that filters out infrared light rays.

5. A semiconductor component, comprising:
an optical sensor chip including a central sensor area and a peripheral electrical connection area;
a transparent cover placed on the chip such that it covers the central sensor area but not the peripheral connection area; and
an infrared filter layer associated with a surface of the transparent cover.

6. The component as in claim 5 wherein the transparent cover is sealed to the optical sensor chip using an annular seal.

7. The component as in claim 5 wherein the infrared filter layer is on a top surface of the transparent cover.

8. The component as in claim 5 further comprising a lens positioned in alignment with the central sensor area.

9. The component as claim 8 further comprising a lens support assembly.
